(19) United States
(12) Patent Application Publication
(10) Pub. No.: US 2023/0279691 A1
(43) Pub. Date: Sep. 7, 2023

(54) HARDTOP CAR-TOP TENT

(71) Applicant: KUO-LIN TSAO, New Taipei City (TW)

(72) Inventor: KUO-LIN TSAO, New Taipei City (TW)

(21) Appl. No.: 17/828,054

(22) Filed: May 31, 2022

(30) Foreign Application Priority Data
Mar. 1, 2022 (TW) 111202030

(51) Int. Cl. E04H 15/06; E04H 15/48

(52) U.S. Cl. CPC E04H 15/06; E04H 15/48

(57) ABSTRACT

A hardtop car-top tent includes first and second casing members, which are respectively formed with first and second accommodation spaces and are pivotally connected to have the first and accommodation spaces corresponding to each other; first support elements, which have two ends respectively mounted to the first and second casing members, such that the first support elements support the first casing member to form a predetermined included angle between the first and second casing members; a second support element, which includes first and second frame members connected between the first and second accommodation spaces of the first and second casing members; and a first covering member, which has two ends respectively connected to the first and second accommodation space, and is positioned against the second support element, so as to make the first covering member forming a front-side surface, a left-side surface, and a right-side surface.

### TECHNICAL FIELD OF THE INVENTION

The present invention relates generally to a tent structure, and more particularly to a hardtop car-top tent that is mountable on a top of an automobile.

### DESCRIPTION OF THE PRIOR ART

The living standard of the modern people is getting increasingly higher, and more and more attention is paid to entertainment activities, such as travelling, camping, and fishing.

However, people taking a long journey often encounter an embarrassing situation of no hotel reservation being available at the last moment, or in certain cases, tents are used as accommodation for the purposes saving expenses, yet it may be hard to find a camping place for building up a text. These situations make a leisure journey change into an exhausted trip, and things turn out just against the hope for joyfulness.

To cope with such situations, some of the people who love to drive a recreation car or a sport utility vehicle (SUV) to do such leisure activities. An SUV or recreation car is generally design for leisure journeys and often has a large inside space, so that people may sleep inside the car comfortably. Yet, it is still a challenge to provide people driving sedan with accessory gears to allow those people to enjoy a leisure trip in a similarly comfortable way.

### SUMMARY OF THE INVENTION

In view of the above problems, the present invention provides a hardtop car-top tent, which comprise: a first casing member, which has one side that is formed with a first accommodation space in communication with an outside; a second casing member, which has one side that is formed with a second accommodation space in communication with the outside, the second casing member having one end pivotally connected to one end of the first casing member, so that the first accommodation space and the second accommodation space are made corresponding to each other; a plurality of first support elements, which have two ends respectively mounted to the first casing member and the second casing member at two sides thereof, so that when the first casing member is being rotated, the first casing member is supported by the first support elements such that a predetermined included angle is formed between the first casing member and the second casing member; a second support element, which comprises at least one first frame member and a second frame member, one end of the first frame member being connected to an interior of the first accommodation space, two ends of the second frame member being connected, at intervals, to an interior of the second accommodation space, an opposite end of the first frame member being detachably connected between the two ends of the second frame member; and a first covering member, which has a top end and a bottom end that are respectively connected to an edge inside the first accommodation space and an edge inside the second accommodation space, an inside of the first covering member being positioned against the second support element, so as to make the first covering member forming a front-side surface, a left-side surface, and a right-side surface.

### BRIEF DESCRIPTION OF THE DRAWINGS

FIG. 1 is a perspective view showing the present invention in a collapsed state.

FIG. 2 is a front view showing the present invention in an expanded state.

FIG. 3 is a cross-sectional elevational view showing a first casing member of the present invention.

FIG. 4 is a perspective view showing the present invention in the expanded state.

FIG. 5 is a schematic view demonstrating a locking and closing operation according to the present invention.

FIG. 6 is a schematic view demonstrating continuation of the operation of FIG. 5.

FIG. 7 is a perspective view showing the present invention in the expanded state.

FIG. 8 is a right-side elevational view of the present invention.

FIG. 9 is a front view of the present invention.

### DETAILED DESCRIPTION OF THE PREFERRED EMBODIMENT

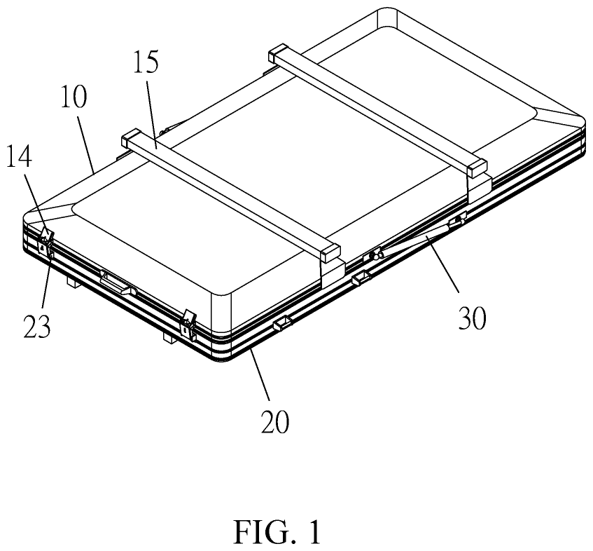

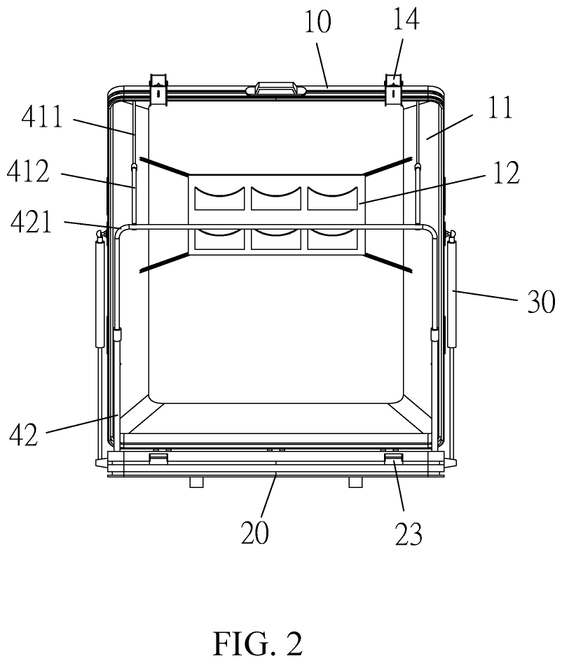

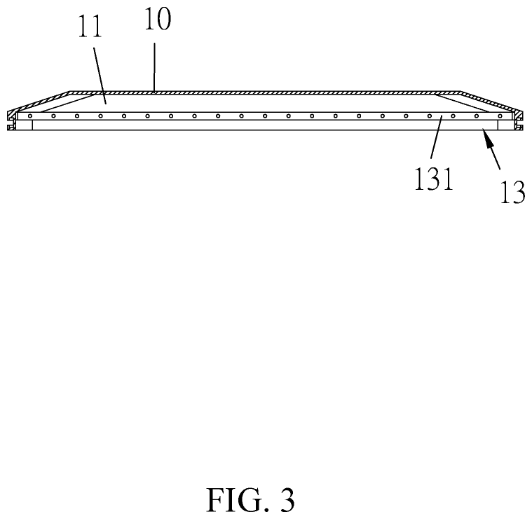

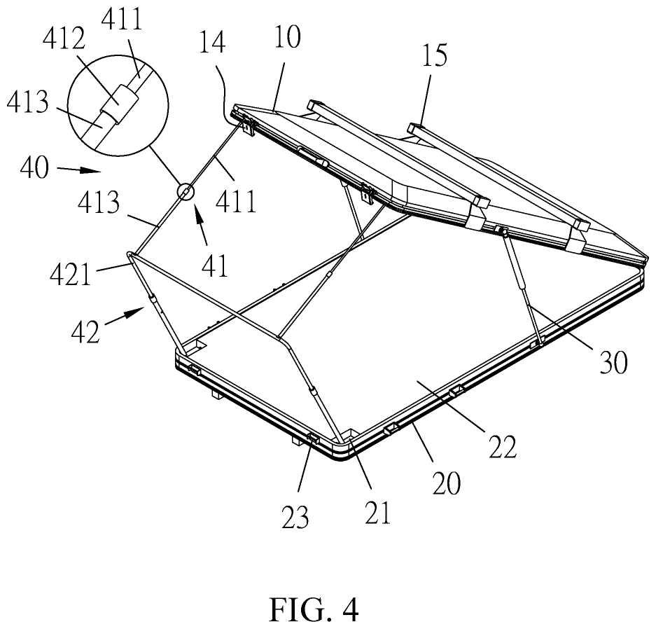

To expound the contents of the present invention and the efficacy achieved thereby, an embodiment will be described with reference to the attached drawings. Referring to FIGS. 1-3, the present invention provides a hardtop car-top tent, which comprises:
a first casing member 10, which has one side that is formed with a first accommodation space 11 in communication with an outside, wherein the first accommodation space 11 is provided, in an interior thereof with a storage bag 12 and a lighting unit 13, which comprises a plurality of luminous elements 131, the luminous elements 131 being circumferentially arranged, at intervals, along a circumference inside the first accommodation space 11, the lighting unit 13 being provided to electrically connect to a mobile power supply (not shown in the drawings); and further, the present invention may be arranged, according to requirements, to form in the first casing member 10 with an opening, the opening being provided with a transparent board (not shown in the drawings), the opening being further provided, in a detachable manner on an outside thereof, with a cover board to cover the opening or the transparent board; and
a second casing member 20, which, referring to FIGS. 2 and 4, has one side that is formed with a second accommodation space 21 in communication with the outside, the second casing member 20 having one end pivotally connected to one end of the first casing member 10, so that the first accommodation space 11 and the second accommodation space 21 are made corresponding to each other, wherein the second accommodation space 21 is provided, in an interior thereof according to requirements, with a mat 22.

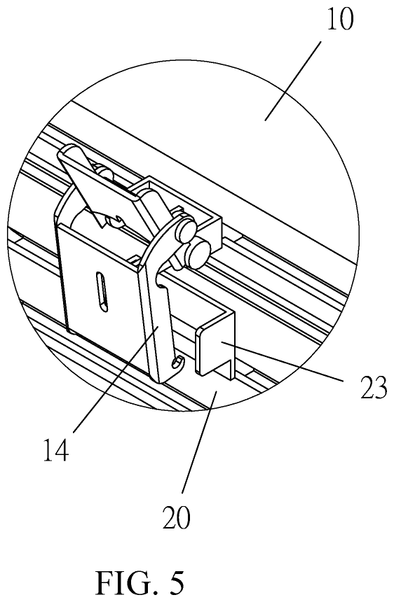

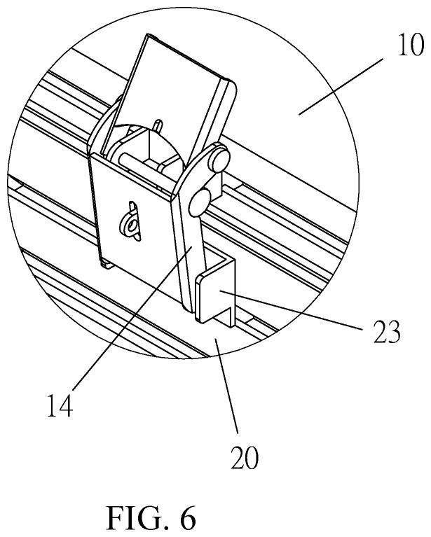

Referring to FIGS. 4-6, the first casing member 10 and the second casing member 20 are respectively provided, at intervals on the outside thereof, with a plurality of first connection members 14 and a plurality of second connection members 23. When the first casing member 10 and the second casing member 20 are closed together, the first connection members 14 may be respectively set in engagement with the second connection members 23 for connection. Further, the first casing member 10 has a top surface that is provided, according to requirements, with an article support frame 15 mounted thereon.

A plurality of first support elements 30 are provided, having two ends respectively mounted to the first casing member 10 and the second casing member 20 at two sides thereof, so that when the first casing member 10 is being rotated, the first casing member 10 is supported by the first support elements 30 such that a predetermined included angle is formed between the first casing member 10 and the second casing member 20, and in the instant embodiment, the first support elements 30 are each a hydraulic rod.

Referring to FIGS. 2 and 4, at least one second support element 40 is provided, comprising at least one first frame member 41 and a second frame member 42, wherein one end of the first frame member 41 is connected to an interior of the first accommodation space 11, and two ends of the second frame member 42 are connected, at intervals, to an interior of the second accommodation space 21, and an opposite end of the first frame member 41 is connected between the two ends of the second frame member 42.

The two ends of the first frame member 41 are connected, in a pivoted manner or in a detachable manner, to the interior of the first accommodation space 11 and between the two ends the second frame member 42, and the second frame member 42 is provided, at intervals, with two curved sections 421 and exhibits an inverted U-shape, allowing the two ends of the second frame member 42 to pivotally connect to the interior of the second accommodation space 21, wherein the two ends of the second frame member 42 are provided with an extendible/retractable structure, and in a stowage state of the present invention, the extendible/retractable structure can be applied to shorten the two ends of the second frame member 42, for being laid flat inside the second casing member 20 through rotation.

The first frame member 41 comprises a first bar 411, a connecting piece 412, and a second bar 413, and one end of the first bar 411 is connected, in a pivoted manner or in a detachable manner, to the interior of the first accommodation space 11, and an opposite end is pivoted to the connecting piece 412, and one end of the second bar 413 is pivoted to the connecting piece 412, and an opposite end is connected between the two ends of the second frame member 42, so that when the first casing member 10 and the second casing member 20 are to be collapsed and closed toward each other, the first frame member 41 can be detached or retracted.

In the embodiment of the present invention (FIG. 4), a plurality of first frame members 41 are included and are mounted on the second frame member 42 to be respectively adjacent to the curved sections 421.

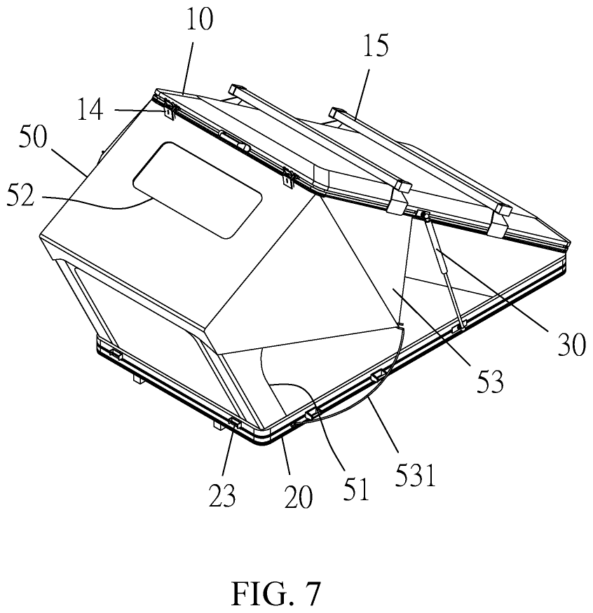

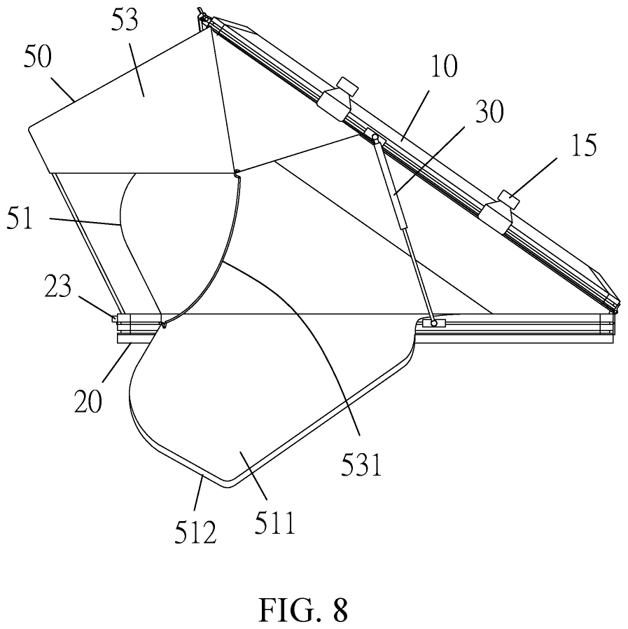

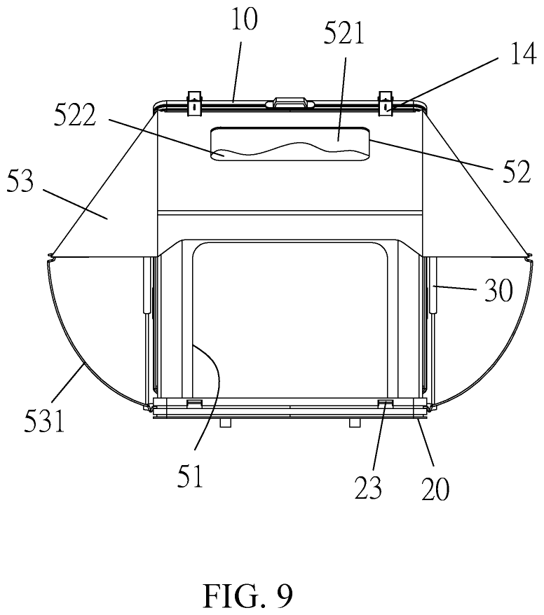

Referring to FIGS. 7-9, a first covering member 50 is provided, having a top end and a bottom end that are respectively connected to an edge inside the first accommodation space 11 and an edge inside the second accommodation space 21, and an inside of the first covering member 50 is set positioned against the second support element 40, so as to make the first covering member 50 forming a front-side surface, a left-side surface, and a right-side surface.

The first covering member 50 is formed with at least one doorway opening 51 and at least one window opening 52, and a first shielding panel 511 and a second shielding panel 512 are provided on one side on an inside of the doorway opening 51, and the first shielding panel 511 and the second shielding panel 512 are each connected, in a detachable manner, to the doorway opening 51, wherein the first shielding panel 511 is located between the doorway opening 51 and the second shielding panel 512, and the second shielding panel 512 is provided with a plurality of small apertures that provide an effect of ventilation and prevention of invasion of insets and mosquitos.

The window opening 52 is combined with a transparent panel 521, and a third shielding panel 522 is provided on an inside of the window opening 52, and the third shielding panel 522 is connected, in a detachable manner, to an inner side of the first covering member 50 and covers the window opening 52, wherein the window opening 52 is corresponding to and arranged between the first frame member 41; and the two ends of the second frame member 42 are located on two sides of the doorway opening 51.

To expand the present invention, the extendible/retractable structure is used to elongate the two ends of the second frame member 42, and the two ends of the second frame member 42 are rotated toward the outside for a predetermined angle so as to form an included angle between each of the first frame members 41 and the second frame member 42, and in brief, each of the first frame members 41 and the second frame member 42 are made protruding toward the outside, while the front-side surface of the first covering member 50 covers the outside of each of the second frame members 41 and the second frame member 42, so as to increase an inside space of the tent to make a user more comfortable.

Further, the left-side surface and the right-side surface of the first covering member 50 are further extended to form an eave plate 53, and each of the eaves plate 53 is located above the doorway opening 51, and a periphery of the eaves plate 53 is connected, in a detachable manner, with at least one third support element 531, and an opposite end of the third support element is detachably connected to an outside of the second casing member 20, so as to make the eaves plates 53 in a three-dimensional form, and the eaves plates 53 fulfill a function of rain shielding and maintaining ventilating of the doorway and window.

I claim:

1. A hardtop car-top tent, comprising:
a first casing member, which has one side that is formed with a first accommodation space in communication with an outside;
a second casing member, which has one side that is formed with a second accommodation space in communication with the outside, the second casing member having one end pivotally connected to one end of the first casing member, so that the first accommodation space and the second accommodation space are made corresponding to each other;
a plurality of first support elements, which have two ends respectively mounted to the first casing member and the second casing member at two sides thereof, so that when the first casing member is being rotated, the first casing member is supported by the first support elements such that a predetermined included angle is formed between the first casing member and the second casing member;
a second support element, which comprises at least one first frame member and a second frame member, one end of the first frame member being connected to an interior of the first accommodation space, two ends of the second frame member being connected, at intervals, to an interior of the second accommodation space, an opposite end of the first frame member being detachably connected between the two ends of the second frame member; and
a first covering member, which has a top end and a bottom end that are respectively connected to an edge inside the first accommodation space and an edge inside the second accommodation space, an inside of the first covering member being positioned against the second support element, so as to make the first covering member forming a front-side surface, a left-side surface, and a right-side surface.

2. The hardtop car-top tent according to claim 1, wherein the first casing member and the second casing member are respectively provided, at intervals on an outside thereof, with a plurality of first connection members and a plurality of second connection members, and when the first casing member and the second casing member are closed together, the first connection members are respectively set in engagement with the second connection members for connection.

3. The hardtop car-top tent according to claim 2, wherein the first accommodation space of the first casing member is provided therein with a lighting unit, which comprises a plurality of luminous elements, the luminous elements being circumferentially arranged, at intervals, along a circumference inside the first accommodation space.

4. The hardtop car-top tent according to claim 3, wherein the first accommodation space is provided, in a detachable manner, in an interior thereof with a storage bag.

5. The hardtop car-top tent according to claim 1, wherein the two ends of the first frame member are connected, in a pivoted manner or in a detachable manner, to the interior of the first accommodation space and between the two ends the second frame member, and the second frame member is provided, at intervals, with two curved sections, allowing the two ends of the second frame member to connect, in a pivotal manner or in a detachable manner, to the interior of the second accommodation space.

6. The hardtop car-top tent according to claim 1, wherein the first frame member comprises a first bar, a connecting piece, and a second bar, one end of the first bar being connected, in a pivoted manner or in a detachable manner, to the interior of the first accommodation space, an opposite end being pivoted to the connecting piece, one end of the second bar being pivoted to the connecting piece, an opposite end being connected between the two ends of the second frame member.

7. The hardtop car-top tent according to claim 5, wherein the first frame member comprises a first bar, a connecting piece, and a second bar, one end of the first bar being connected, in a pivoted manner or in a detachable manner, to the interior of the first accommodation space, an opposite end being pivoted to the connecting piece, one end of the second bar being pivoted to the connecting piece, an opposite end being connected between the two ends of the second frame member.

8. The hardtop car-top tent according to claim 1, wherein the first covering member is formed with at least one doorway opening and at least one window opening, a first shielding panel and a second shielding panel being provided on one side on an inside of the doorway opening, the first shielding panel and the second shielding panel being each connected, in a detachable manner, to the doorway opening; the window opening is combined with a transparent panel, a third shielding panel being provided on an inside of the window opening, the third shielding panel being connected, in a detachable manner, to an inner side of the first covering member and covering the window opening; and the two ends of the second frame member are located on two sides of the doorway opening.

9. The hardtop car-top tent according to claim 8, wherein the first shielding panel is located between the doorway opening and the second shielding panel, and the second shielding panel is provided with a plurality of small apertures in order to prevent invasion of insets and mosquitos.

10. The hardtop car-top tent according to claim 1, wherein each of the first support elements comprises a hydraulic rod.

11. The hardtop car-top tent according to claim 1, wherein the left-side surface and the right-side surface of the first covering member are extended to form an eave plate, each of the eave plates being located above the doorway opening, a periphery of the eaves plate being connected, in a detachable manner, with at least one third support element, an opposite end of the third support element being detachably connected to an outside of the second casing member.

12. The hardtop car-top tent according to claim 1, wherein the second frame member is provided, at intervals, with two curved sections, two ends of the second frame member being provided with an extendible/retractable structure, so that to stow, the extendible/retractable structure is applicable to shortening two ends of the second frame member for being laid flat inside the second casing member through rotation; and to expand, the extendible/retractable structure is applicable to elongating the two ends of the second frame member, and the two ends of the second frame member are rotated toward the outside for a predetermined angle, so as to have each of the first frame members and the second frame member protruding toward the outside, and the front-side surface of the first covering member covers the outside of each of the second frame members and the second frame member.
